(19) United States
(12) Patent Application Publication
(10) Pub. No.: US 2024/0142269 A1
(43) Pub. Date: May 2, 2024

(54) SYSTEM AND METHOD FOR PROVIDING FLIGHT GUIDANCE DURING A PARABOLIC MANEUVER

(71) Applicant: MU-G Technologies, LLC, Titusville, FL (US)

(72) Inventors: Robert Ward, Titusville, FL (US); Paul Sierpinski, Titusville, FL (US)

(73) Assignee: MU-G Technologies, LLC, Titusville, FL (US)

(21) Appl. No.: 18/491,952

(22) Filed: Oct. 23, 2023

Related U.S. Application Data
(60) Provisional application No. 63/380,956, filed on Oct. 26, 2022.

(51) Int. Cl. G01C 23/00

(52) U.S. Cl. CPC G01C 23/005

(57) ABSTRACT

A flight management system for providing guidance to a pilot during parabolic maneuvers including (1) an aircraft computer; (2) on-board storage; (3) a processor including instructions for receiving a target guidance parameter from the on-board storage, comparing the target guidance parameter to a value of a plurality of outputs of the aircraft computer to provide a guidance parameter having a value to a display; and (4) the display adapted to provide a visual indication to the pilot only during a maneuver execution phase wherein the visual indication is indicative of a target stick deflection based upon the value of the guidance parameter.

### RELATED APPLICATIONS

This application claims priority under 35 U.S.C. § 119(e) of U.S. Provisional Patent Application Ser. No. 63/380,956 (Attorney Docket No. 4996.00003) filed on Oct. 26, 2022 and titled SYSTEM AND METHOD FOR PROVIDING FLIGHT GUIDANCE DURING A PARABOLIC MANEUVER. The content of this application is incorporated herein by reference.

### FIELD OF THE INVENTION

The present invention relates to systems and methods for providing guidance to a pilot executing a parabolic maneuver.

### BACKGROUND OF THE INVENTION

As space tourism and adventure seeking grows in popularity, there is an increasing demand for aircraft to perform parabolic maneuvers that give passengers the experience of weightlessness, reduced gravitational forces, or simulate the gravitational forces experienced on celestial bodies other than Earth. With this increased demand, there is a corresponding increase in the need to make such maneuvers safe for passengers. There is a need for a system that monitors aircraft parameters and provides feedback to the pilot to optimize the experience for the passenger and maintains safety throughout the maneuver.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a flight management system for providing guidance to a pilot during parabolic maneuvers. The flight management system may include an aircraft computer, on-board storage, a processor, and a display.

The processor may include instructions for receiving a target guidance parameter from the on-board storage, comparing the target guidance parameter to a value of a plurality of outputs of the aircraft computer to provide a guidance parameter, which has a value, to the display.

The display may be adapted to provide a visual indication to the pilot only during a maneuver execution phase wherein the visual indication is indicative of a target stick deflection based upon the value of the guidance parameter.

The processor may include instructions to compare the value of the plurality of outputs of the aircraft computer, which may be indicative of a gravitational force, to a threshold gravitational force value and enter the maneuver execution phase if the value of the plurality of outputs of the aircraft computer indicative of the gravitational force exceed the threshold gravitational force value.

The threshold gravitational force value may be equal to or greater than 1.3 g.

The processor may include instructions to compare the value of the plurality of outputs of the aircraft computer, which may be indicative of a gravitational force, to a threshold gravitational force value and enter the maneuver execution phase if the value of the plurality of outputs of the aircraft computer indicative of the gravitational force exceed the threshold gravitational force value for longer than a threshold time.

The threshold gravitational force value may be equal to or greater than 1.3 g and the threshold time may be greater than or equal to 0.5 seconds.

The processor may include instruction to calculate a parabolic trajectory resulting in a target gravitational force at an apex of the parabolic trajectory.

The display may be adapted to provide a second visual indication to the pilot indicative of a number of parabolic trajectories that have been flown.

The processor may iteratively calculate the guidance parameter based on an updated target guidance parameter and an updated value of the plurality of outputs of the aircraft computer.

The processor may iteratively calculate the guidance parameter based on an updated target guidance parameter and an updated value of the plurality of outputs of the aircraft computer only in the maneuver execution phase.

The processor may include instruction to compare the plurality of outputs of the aircraft computer to an abort criteria to provide an abort status.

The display may be adapted to provide a second visual indication to the pilot indicative of the abort status.

### BRIEF DESCRIPTION OF THE DRAWINGS

Some embodiments of the present invention are illustrated as an example and are not limited by the figures of the accompanying drawings, in which like references may indicate similar elements.

FIG. 1 is a flowchart of an inventive method according to an embodiment of the present invention.

FIG. 2 is a block diagram of a flight management system according to an embodiment of the present invention.

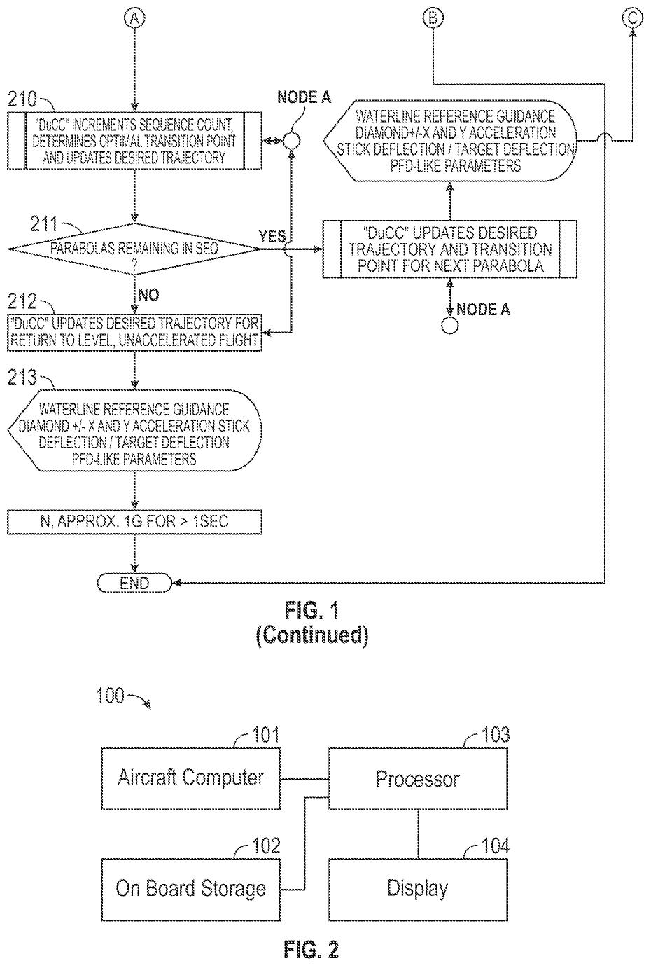

FIG. 3 is a front elevation view of the display according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system and method for providing flight guidance to a pilot during a parabolic maneuver.

The flight management system 100 may be utilized as a tool for aircraft pilots to improve the accuracy, duration, and repeatability of parabolic maneuvers for the purposes of, but not limited to, microgravity research, “astronaut” and/or aircrew training, space tourism, corporate events, marketing, filming, entertainment, or the like. The flight management system 100 may include an aircraft computer 101, on board storage 102, processor 103, and display 104. At a high level, the system collects, aggregates, processes, and stores data from the aircraft computer 101. By way of example, and not as a limitation, the aircraft computer is understood to encompass the aircraft's on-board Altitude Heading Reference System, other sensors on the aircraft, a simulator processor, and additional “bolt-on” instrumentation. By way of example, and not as a limitation, data that may be provided to the processor from the aircraft computer 101 may include Angle of Attack (AoA) vanes or probes, pitot-static system, GPS, inertial navigation unit, accelerometers, thermometers or thermocouples, Full Authority Digital Engine Controller (FADEC) data, flight computer data, or the like.

In embodiments in which the system 100 is used on a simulator, data may be provided to the processor 103 through an Ethernet port. In embodiments in which the system 100 is used on an aircraft, data may be provided to the processor 103 via an interface with the aircraft's own ARINC-429 bus (see Table 1 for simulated aircraft data outputs from the aircraft computer 101 that may be provided to the processor 103). In instances in which the aircraft or simulator has additional “bolt-on” (after-market, purpose installed) instrumentation, a suitable data standard and interface, which may not be ARINC-429 such as machine learning or predictive modeling, may provide data to the processor 103.

TABLE 1
Exemplary aircraft data output that may be provided to the processor 103

| | Buffer | | | | Size | |
|---|---|---|---|---|---|---|
| Index | Position | Parameter | SIM Interpretation | Unit | (byte) | Type |
| 1 | 0 | | Load Factor Body (X) [Positive FWD] | g | 8 | double |
| 2 | 8 | GGx | Load Factor Body (Y) [Positive LEFT] | g | 8 | double |
| 3 | 16 | Gz | Load Factor Body (Z) [Positive UP] | g | 8 | double |
| 4 | 24 | Stick Position X | Captain's Roll Control Input [Positive LEFT] | deg | 8 | double |
| 5 | 32 | Stick Position Y | Captain's Pitch Control Input [Positive FWD] | deg | 8 | double |
| 6 | 10 | Stick Force * | — | — | 0 | — |
| 7 | 40 | Airspeed | Calibrated Airspeed (CAS) | kt | 8 | double |
| 8 | 48 | Airspeed Trend | Speed Trend Arrow (Captain's PFD) | kt | 8 | double |
| 9 | 56 | Altitude | Altitude Above MSL | ft | 8 | double |
| 10 | 64 | Heading | Magnetic Heading | rad | 8 | double |
| 11 | 72 | Pitch | Pitch [Positive UP] | deg | 8 | double |
| 12 | 80 | Roll | Roll [Positive RIGHT] | deg | 8 | double |
| 13 | 88 | Mmo ** | VMO/MMO (Captain's PFO) | kt | 8 | double |
| 14 | 96 | Vs | Stall Speed | kt | 8 | double |
| 15 | 104 | Throttle Position | Engine 1 Thrust Lever Angle (TLA1) | deg | 8 | double |
| 16 | 112 | Engine 2 Thrust | | deg | 8 | double |
| | | Lever Angle (TLA2) | | | | |
| 17 | 120 | Gross Weight | Gross Weight | kg | 8 | double |
| 18 | 128 | Fuel Load | Total Fuel Weight | kg | 8 | double |
| 19 | 136 | TAS | True Airspeed | kt | 8 | double |
| 20 | 144 | OAT | Outside Air Temperature | K (abs) | 8 | double |

Utilizing the data from any combination of one or more of the aircraft computers 101, along with any pre-determined flight parameters, which may be configurable, an stored in onboard storage 102, the processor 103 calculates an ideal parabolic trajectory. During flight the processor 103 calculates the aircraft's deviation from ideal trajectory based on inputs from aircraft computer 101 and provides this information to the display 104. The information is presented on the display 104 to prompt the pilot to aid in the entry in to, maintenance of, and termination of the maneuver.

The on-board storage 101 may store pertinent data received, processed, or output (parameters coming in, calculated values, and displayed parameters, guidance, or cueing). These data may be made available on the on-board storage 101 post-flight for individual maneuver quality grading per applicable standards, training, marketing, or flight reconstruction purposes.

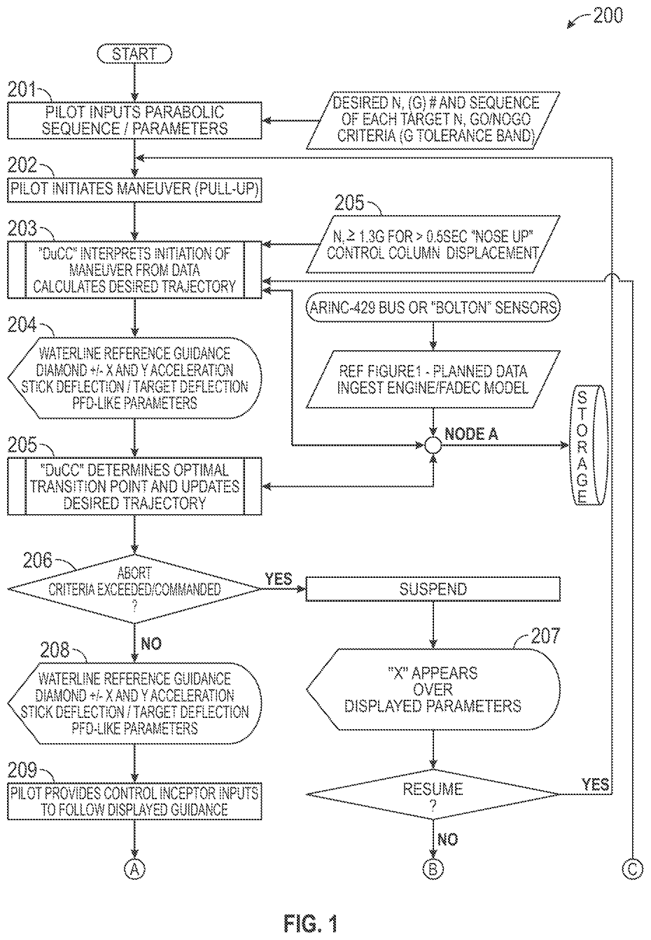

A logical flow block diagram of one embodiment of the system's in-flight concept of operation is presented as FIG. 1. The method 200 may have four basic modes of operations: pre-maneuver, maneuver execution, maneuver abort/sequence suspension, and ground maintenance. Each of these modes are addressed in greater detail below.

### Pre-Maneuver

The on-board storage 102 may be programmed pre-flight with the intended flight profile and parameters for the parabolic maneuvers (e.g., total number of parabolas for each target gz, or “g”, g tolerance band, abort criteria, etc.) 201. After programming, the operator of the system may place the system 100 in a stand-by mode for all critical phases of flight. Once in-flight, the system 100 may be updated by the operator at any point, except mid-maneuver (application of gz loading ≥1.3 g for 0.5 sec until return to 1.0 g+/−0.1 g for >3 sec). When the system 100 is out of stand-by mode and activated, the system 100 may display, through a connected and dedicated display 104 or by other means, various aircraft parameters similar to what would be found on Airbus' or another aircraft's Flight Management System (FMS) and Primary Flight Display (PFD) as well as ideal maneuver entry criteria (e.g., altitude, airspeed, attitude, engine power setting). The pilot may initiate a maneuver 202. Upon detection of the maneuver trigger, the system 100 may enter into a maneuver execution mode and calculate the desired trajectory for the maneuver 203.

Standardized parameters and profiles may be configured and stored within the onboard storage 102 for rapid programming and verification. Provisions for configuration management of these files through standard software methodologies, such as version numbering, compile dates, and/or checksums, shall be included in the system's operator interface.

### Maneuver Execution

By default, the system 100 may define maneuver entry criteria as aircraft gz ≥1.3 g for 0.5 sec 205. However, this parameter may be configurable and updateable by the operator. Updates to these parameters may be saved in on-board storage 102. Upon detecting the maneuver entry criteria condition, the system 100 may transition into a maneuver guidance mode 203. In this state, the processor 103 may continuously update the ideal trajectory, as well as current and future deviation from the ideal trajectory (based on trends and aircraft performance models) 205. The system 100 may continuously provide the pilot, via the display 104 or other means, with aircraft attitude symbology (e.g. waterline or ownship), a guidance (fly to) diamond, airspeed, airspeed trend, and preparatory guidance such as flashing arrows indicating imminent control stick changes (push/pull), flashing/boxing/colorizing of airspeed and airspeed trend to indicate imminent power (throttle) changes 204. The system may also be capable of providing auditory cues, which will be operator configurable, if authorized by the FAA or other competent authorities' certifications and/or imposed operational limitations. The processor 103 may monitor abort criteria 206. If abort criteria are met, the processor 103 may provide information to the display 104 to present the abort conditions to the pilot 207. Provided abort conditions are not met, the display 104 may continue to provide guidance to the pilot to execute the maneuver 208. Additional cues may include a prompt to relax stick pull force as the aircraft approached high pitch angles and stall speed, and a visual representation of where in a maneuver and overall profile of all planned maneuvers the aircraft is currently operating based in the system's own guidance solution (this may be implemented as a side scroll representation of an index mark, sine-like waves, and numerical count). The pilot will follow the guidance provided by the display 104 until the sequence execution is completed 209.

Upon completion of the maneuver, the processor 103 may increment a counter visible on the display 104 for pilot reference 210. The system 100 may also display guidance for level off (if at the end of the programmed sequence) or entry into the next maneuver 210. The process outlined above will repeat for all subsequent maneuvers until the sequence is complete 211, abort criteria is detected 206, or the operator manually suspends/aborts the maneuver. The sequence, or particular maneuver, shall be capable of suspension or abort at any time either by operator input or exceedance of designated abort criteria.

At the completion of each maneuver, a visual element or display effect may be utilized to prompt the pilot to refer back to the PFD for recovery from the pitch down aircraft attitude. The processor 103 may continue ingesting data and calculating updates to planned guidance throughout this period 212. The system 100 may return to displaying maneuver guidance as the aircraft transitions from negative to positive pitch angles 213. During the maneuver recovery, the total time spent within the previously specified maneuver bounds of the immediately prior maneuver will be displayed for the pilot and/or operator.

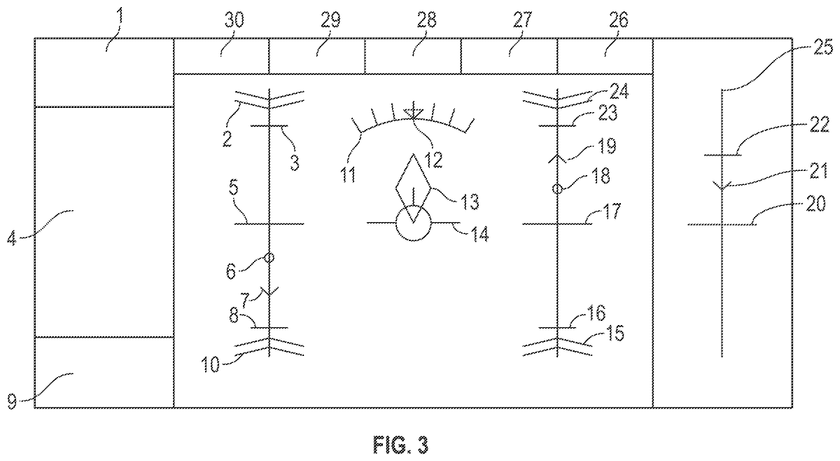

FIG. 3 depicts an embodiment of the display 104 that may be provided to the operator. The reference numerals shown in FIG. 3 refer to the items as identified in Table 2.

TABLE 2

| Reference | |
|---|---|
| Numeral | Description |
| 1 | Parabola Counter (##/##) |
| 2 | CAPT Push Over Guidance Chevron |
| 3 | CAPT Pull Up Target |
| 4 | Status Message Box |
| 5 | CAPT Sidestick Neutral Point |
| 6 | CAPT Sidestick Position |
| 7 | CAPT Sidestick Position Trend Vector (3 sec.) |
| 8 | CAPT Push Over Target |
| 9 | Previous Parabola Duration/Score |
| 10 | CAPT Pull Up Guidance Chevron |
| 11 | Roll Scale |
| 12 | Roll Scale Pointer |
| 13 | Parabola Guidance Diamond |
| 14 | Flight Path Marker |
| 15 | F/O Pull Up Guidance Chevron |
| 16 | F/O Push Over Target |
| 17 | F/O Sidestick Neutral Point |
| 18 | F/O Sidestick Position |
| 19 | F/O Sidestick Position Trend Vector (3 sec.) |
| 20 | Longitudinal G Target |
| 21 | Longitudial G Trend Vector (3 sec.) |
| 22 | Longitudinal G |
| 23 | F/O Pull Up Target |
| 24 | F/O Push Over Guidance Chevron |
| 25 | Longitudinal G Bar |
| 26 | Status Box |
| 27 | Next Event |
| 28 | Current Event (PULL, PUSH, ZG, LG, MG, AG, etc.) |
| 29 | Previous Event |
| 30 | Status Box |

### Maneuver Abort/Sequence Suspension

If at any time during the maneuver the processor 103 detects an exceedance of abort criteria, or the operator manually commands an abort or suspend, the processor 103 may continue to update trajectories and perform internal computation of parameters and store these data to on-board storage 102. However, the processor 104 may discontinue providing any preparatory guidance and cueing for the maneuver and place a red “X” over all display elements no longer being updated. At this point it is incumbent on the pilot at the controls to recover from any conditions or unusual attitudes per standard procedures and training standards. Once the processor 103 detects level flight, it will enter into a suspend mode, wherein it directs the display 104 to remove all guidance and cueing displays and provide parameters and displays similar to pre-maneuver modes. The system 100 may await input from the operator as to completion or continuation of the sequence. At this time, the operator may also update the flight parameters for use in maneuvers that follow. Upon selection of an option to resume, the processor 103 may incorporate any parameter updates that may have been made and re-enter its logic at the pre-maneuver state. Upon selection of the option to terminate, the processor 103 will complete any pending data storage to on-board storage 102, proceed to end state, and re-enter stand-by mode.

### Ground Maintenance

The system 100 shall be capable of updating software, configuration files, and standardized parameter libraries while in a powered up but inactive state. Within this operating environment, the system 100 may also provide the capability to retrieve and/or download data from previous flights that is saved in on-board storage 102. Should the data standard chosen be of a proprietary or encrypted nature, the system interface may provide a means of converting this data into .csv or other human readable format for purposes previously discussed.

The system may incorporate Power-On System Test (POST) and Built-in Test (BIT) modes as recommended by the hardware manufacturer and competent authorities.

The system 100 is not intended as a modification to aircraft or aircraft systems, but as a consumer of data provided by the aircraft for processing, display, and storage. As such, maintenance or troubleshooting beyond the integrated test modes mentioned above are not planned for inclusion in any aircraft manufacturer's maintenance plans or procedures for Preventive Maintenance (PM), line, or A/B/C/D-checks. Any significant troubleshooting or repair of the system 100 will be performed by the system manufacturer or other subject matter experts appropriately familiar with and/or certified to perform such tasks, and those tasks shall not be conducted in such a way as to break any aircraft certification.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A flight management system for providing guidance to a pilot during parabolic maneuvers comprising:
an aircraft computer;
on-board storage;
a processor including instructions for receiving a target guidance parameter from the on-board storage, comparing the target guidance parameter to a value of a plurality of outputs of the aircraft computer to provide a guidance parameter having a value to a display; and
the display adapted to provide a visual indication to the pilot only during a maneuver execution phase wherein the visual indication is indicative of a target stick deflection based upon the value of the guidance parameter.

2. The system of claim 1 wherein the processor includes instructions to compare the value of the plurality of outputs of the aircraft computer indicative of a gravitational force to a threshold gravitational force value and enter the maneuver execution phase if the value of the plurality of outputs of the aircraft computer indicative of the gravitational force exceed the threshold gravitational force value.

3. The system of claim 2 wherein the threshold gravitational force value is equal to or greater than 1.3 g.

4. The system of claim 1 wherein the processor includes instructions to compare the value of the plurality of outputs of the aircraft computer indicative of a gravitational force to a threshold gravitational force value and enter the maneuver execution phase if the value of the plurality of outputs of the aircraft computer indicative of the gravitational force exceed the threshold gravitational force value for longer than a threshold time.

5. The system of claim 4 wherein the threshold gravitational force value is equal to or greater than 1.3 g and the threshold time is greater than or equal to 0.5 seconds.

6. The system of claim 1 wherein the processor includes instruction to calculate a parabolic trajectory resulting in a target gravitational force at an apex of the parabolic trajectory.

7. The system of claim 6 wherein the display is adapted to provide a second visual indication to the pilot indicative of a number of parabolic trajectories that have been flown.

8. The system of claim 4 wherein the processor iteratively calculates the guidance parameter based on an updated target guidance parameter and an updated value of the plurality of outputs of the aircraft computer.

9. The system of claim 4 wherein the processor iteratively calculates the guidance parameter based on an updated target guidance parameter and an updated value of the plurality of outputs of the aircraft computer only in the maneuver execution phase.

10. The system of claim 1 wherein the processor includes instruction to compare the plurality of outputs of the aircraft computer to an abort criteria to provide an abort status.

11. The system of claim 6 wherein the display is adapted to provide a second visual indication to the pilot indicative of the abort status.
